(19) United States
(12) Patent Application Publication
(10) Pub. No.: US 2011/0029433 A1
(43) Pub. Date: Feb. 3, 2011

(54) IMPORT/EXPORT TRANSACTION FACILITY

(76) Inventor: Chee Min Thoo, Killara (AU)

Correspondence Address: KNOBBE MARTENS OLSON & BEAR LLP, 2040 MAIN STREET, FOURTEENTH FLOOR, IRVINE, CA, 92614, US

(21) Appl. No.: 12/901,436

(22) Filed: Oct. 8, 2010

Related U.S. Application Data
(63) Continuation-in-part of application No. PCT/AU2009/000425, filed on Apr. 8, 2009.

(30) Foreign Application Priority Data
Apr. 10, 2008 (AU) 2008201615
Nov. 5, 2008 (AU) 2008243115

(51) Int. Cl. G06Q 40/00

(52) U.S. Cl. 705/40

(57) ABSTRACT

An import/export facility; said facility including computer implemented software resident on servers and databases maintained by a Central Control Facility; said software providing for registration of Importers and Exporters and at least one Bank in each country of operation of registered said Importers and Exporters; said registration effected by accessing Internet web pages generated and transmitted by said software; said at least one Bank registering on behalf of a said registered Importer, a Hybrid Bank Guarantee with said Central Control Facility; a registered Exporter registering with said Central Control Facility an invoice against said Hybrid Bank Guarantee for a transaction with a said registered Importer, and wherein said software executes steps to monitor registered invoices against said Hybrid Bank Guarantee; said steps including:
(e) adding the value of an invoice submitted for registration to a sum of values of invoices (if any) prior registered against said Hybrid Bank Guarantee to derive a total value,
(b) comparing said derived total value to the value of said registered Hybrid Bank Guarantee against which said invoice was submitted for registration,
(c) registering said invoice against said registered Hybrid Bank Guarantee of the registered Importer to whom said invoice is directed if said total value does not exceed the value of said Hybrid Bank Guarantee,
(d) maintaining registration of a said invoice for a period nominated by a said registered Exporter on payment of a registration fee,
and wherein said computer system rejects for registration any invoice submitted for registration by a said Exporter against a said Hybrid Bank Guarantee if said derived total value is greater than the value of said Hybrid Bank Guarantee; said computer system generating, and causing to be transmitted, email advice of rejection to said Exporter and to said Importer; and wherein said Exporter may claim against said Hybrid Bank Guarantee if payment of a registered invoice is not made by said Importer within a nominated registration period of said invoice.

### CROSS-REFERENCE TO RELATED APPLICATIONS

This application is a continuation-in-part of PCT Application No. PCT/AU2009/00425 filed Apr. 8, 2009 entitled Import/Export Transaction Facility which claims priority to Australian Patent Application No. AU 2008201615 filed Apr. 10, 2008 and Australian Patent Application No. AU 2008243115 filed Nov. 5, 2008 which are hereby incorporated by reference in their entirety herein.

### BACKGROUND OF THE INVENTION

The present invention relates to transactions between exporters and importers and, more particularly, to simplification and security of financial transactions between them.

The financial arrangements between an Importer and an Exporter of goods generally involve the banks of both parties and typically either a Letter of Credit or a Bank Guarantee.

The Letter of Credit is an “upfront” payment. The Importer has to pay the full price of the transaction the moment the exported goods are shipped and the relevant documentation is presented. It precludes the provision of credit as in other trade systems and is costly for the Importer.

Moreover, a Letter of Credit can only be used once. A Letter of Credit is required for every import, attracting bank charges for each Letter of Credit issued, with the added disadvantage for the importer of having to go to the bank to arrange each new Letter. Considerable paperwork is involved in the issue of each new Letter and the importer must present a pro-form a invoice as basis for the new Letter of Credit. The establishment of the Letter requires the importer to tie up funds to cover its value.

A further disadvantage of the Letter of Credit is that a bank's liability in regard to a Letter of Credit extends to documentary evidence only and is not concerned with the goods (facts) so that fraud through presentation of bogus documents is possible. Payment is collected at the (alleged) point of shipment of the goods so that should the presented documentation be bogus, this cannot be discovered until later.

As an alternative a Letter of Credit or Open Account transactions, an Importer may provide an Exporter with a Bank Guarantee. One disadvantage of this instrument is that as for the Letter of Credit, it is a one use only instrument. Should an Importer use Open Account in conjunction with a Bank Guarantee, and pay on invoice, there is a possibility of the Exporter cashing in the Bank Guarantee; either because of some unexpected delay in receiving payment or fraudulently. Such double payments are hard to recover.

Another disadvantage associated with trade between an Importer and Exporter is that the importer is denied a period of extended credit for making a purchase from an overseas exporter. As soon as the Exporter has the necessary documentation to indicate shipment of the goods, he is paid by the Letter of Credit, even though it may be some time before the Importer is in receipt of those goods.

There are disadvantages in the Letter of Credit method of trade for the Exporter also. To receive payment the Exporter must present to the paying bank the documentation required to release payment.

The overseas based Exporter also cannot promote sales of his goods by offering extended terms of payment, unless he is prepared to purchase insurance to cover open account trading transactions, but generally this type of insurance is too costly to be a viable option.

The impediments to providing widely geographically separated importers and exporters the benefits of open account trading without incurring the disadvantages, is at least partly due to lack of a mechanism which provides a data storage and communication hub through which security of open account transactions can be mediated.

It is an object of the present invention to address the above disadvantages, by providing a secure open account trading system between Importers and Exporters, in a similar manner to that available between buyers and sellers operating in a local geographic area.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### BRIEF DESCRIPTION OF INVENTION

Accordingly, in a first broad form of the invention, there is provided an import/export facility; said facility including computer implemented software resident on servers and databases maintained by a Central Control Facility; said software providing for registration of Importers and Exporters and at least one Bank in each country of operation of registered said Importers and Exporters; said registration effected by accessing Internet web pages generated and transmitted by said software; said at least one Bank registering on behalf of a said registered Importer, a Hybrid Bank Guarantee with said Central Control Facility; a registered Exporter registering with said Central Control Facility an invoice against said Hybrid Bank Guarantee for a transaction with a said registered Importer, and wherein said software executes steps to monitor registered invoices against said Hybrid Bank Guarantee; said steps including:
(a) adding the value of an invoice submitted for registration to a sum of values of invoices (if any) prior registered against said Hybrid Bank Guarantee to derive a total value,
(b) comparing said derived total value to the value of said registered Hybrid Bank Guarantee against which said invoice was submitted for registration,
(c) registering said invoice against said registered Hybrid Bank Guarantee of the registered Importer to whom said invoice is directed if said total value does not exceed the value of said Hybrid Bank Guarantee,
(d) maintaining registration of a said invoice for a period nominated by a said registered Exporter on payment of a registration fee,
   and wherein said computer system rejects for registration any invoice submitted for registration by a said Exporter against a said Hybrid Bank Guarantee if said derived total value is greater than the value of said Hybrid Bank Guarantee; said computer system generating, and causing to be transmitted, email advice of rejection to said Exporter and to said Importer; and wherein said Exporter may claim against said Hybrid Bank Guarantee if payment of a registered invoice is not made by said Importer within a nominated registration period of said invoice.

Preferably, each of a said registered Importer, a said registered Exporter and a said registered Bank, being parties to an import/export transaction, is afforded access to appropriate sections of said databases over the Internet; said access enabled on provision of authentication of identity.

Preferably, registration of an invoice by a said Exporter with said Central Control Facility is for a nominated registration period agreed between a said registered Exporter and a said registered Importer.

Preferably, registration of a said invoice is maintained in said databases by said Central Control Facility on payment of a fee.

Preferably, a said registered Importer makes payment against an invoice registered with said Central Control Facility by any payment means without reference to said Central Control Facility.

Preferably, said computer system of said Central Control Facility alerts each of said registered Exporter, said registered Bank and said registered Importer being parties to an import/export transaction, to the expiry of a said nominated registration period of a said invoice registered against said Hybrid Bank Guarantee.

Preferably, a said registered Exporter is guaranteed payment of a said invoice registered against a said Hybrid Bank Guarantee by said registered Bank which issued said Hybrid Bank Guarantee, if said registration period for said invoice expires without payment of said invoice being received by said Exporter from said Importer.

Preferably, a said registered Exporter who has not received payment from a said registered Importer of a registered invoice at expiry of a said registration period of said invoice, is enabled to register a claim against a said Hybrid Bank Guarantee against which said invoice was registered.

Preferably, said computer implemented software alerts a said registered Bank and a said registered Importer of a claim against a Hybrid Bank Guarantee issued by said Bank in favour of said Importer.

In another broad form of the invention, there is provided a method of securing default payment of an invoice for an import/export transaction between an Exporter and an Importer registered with a Central Control Facility; said method including the steps of:
(a) said Exporter submitting said invoice for registration for a nominated period with said Central Control Facility; said invoice registered against a Hybrid Bank Guarantee issued by a registered Bank and registered with said Central Control Facility in favour of said Importer,
(b) a computer system of said Central Control Facility adding the value of said submitted invoice to a total value of invoices (if any) prior registered against said Hybrid Bank Guarantee to derive a new total value,
(c) said computer system comparing said new total value to the value of said Hybrid Bank Guarantee,
(d) said computer system registering said invoice with said Central Control Facility if said new total value is not greater than said value of said Hybrid Bank Guarantee,
(e) said Exporter registering a claim against said registered Hybrid Bank Guarantee only if said Importer has not paid said registered invoice within said nominated period of registration of said invoice, said registered Bank making payment of said registered invoice to said Importer
   and wherein said computer executes steps, firstly rejecting registration of said invoice, and secondly generating alerting emails to said Exporter and to said Importer, if said new total value is greater than said value of said Hybrid Bank Guarantee.

Preferably, said registered Bank makes payment of said registered invoice only in a default situation; said default situation occurring if:
(a) a said nominated registration period of said registered invoice has expired,
(b) said registered Exporter has registered a claim with said Central Control Facility,
(c) documentary evidence of supply of goods is verified by said registered Bank,
(d) said registered Importer cannot provide proof of payment of said registered invoice.

In another broad form of the invention, there is provided an import/export facilitating computer system providing a communication and data storage hub; said system maintained by a Central Control Facility; said computer including servers and databases accessible over the Internet by registered parties to import/export transactions; said computer system having the following functions:
(a) Generating and transmitting formatted web pages displayable over said Internet for submission by said parties of data for registration of said parties with said Central Control Facility; said parties comprising Exporters, Importers and at least one Bank in each country in which said Exporters and Importers are located,
(b) storage of said data in said databases,
(c) providing formatted web pages for storage of details provided by a registered said Bank of a Hybrid Bank Guarantee issued by said Bank in favour of a registered said Importer,
(d) providing details over the Internet of a registered said Hybrid Bank Guarantee to one or more registered Exporters nominated by said Importer for whom said Hybrid Bank Guarantee was issued,
(e) providing formatted web pages for submitting for registration by a said nominated Exporter one or more invoices against said Hybrid Bank Guarantee,
(f) summing the values of any prior registered invoices against a said Hybrid Bank Guarantee and adding the value of a newly submitted invoice by said nominated Exporter to derive a new total value,
(g) registering said newly submitted invoice against said Hybrid Bank Guarantee if said new total value does not exceed the value of said Hybrid Bank Guarantee,
   and wherein said computer system rejects for registration any invoice submitted for registration by a said nominated Exporter against a said Hybrid Bank Guarantee if said new total value is greater than the value of said Hybrid Bank Guarantee; said computer system generating, and causing to be transmitted, email advice of rejection to said nominated Exporter and to said Importer; and wherein said nominated Exporter may claim against said Hybrid Bank Guarantee if payment of a registered invoice is not received within a nominated period of registration of said invoice.

Preferably, each invoice registered against a said Hybrid Bank Guarantee is registered for a period of registration on payment of a registration fee; said period of registration agreed between a said Exporter and a said Importer for an import/export transaction.

Preferably, said Hybrid Bank Guarantee provides guarantee of payment of an invoice registered with said Central Control Facility against said Hybrid Bank Guarantee if said Importer, in favour of whom said Hybrid Bank Guarantee was issued, has not paid said invoice within a period of registration of said invoice.

In another broad form of the invention, there is provided an import/export transaction facility; said facility including a computer implemented program; said program resident on servers maintained by a Central Control Facility; said program executing steps including:
(a) registering Importers and Exporters with said Central Control Facility,
(b) registering and managing a financial instrument issued in favour of a said registered Importer,
(c) monitoring values of invoices submitted for registration against said financial instrument,
   wherein said Central Control Facility acts as a third party monitor in the execution of said financial instrument; said financial instrument comprising a Hybrid Bank Guarantee whereby said Hybrid Bank Guarantee guarantees payment of an invoice registered by said Central Control Facility against said Hybrid Bank Guarantee if said invoice is not paid by said registered Importer within a period of registration of said invoice.

Preferably, said financial instrument combines principles of both a letter of credit and a bank guarantee; said financial instrument forming a Hybrid Bank Guarantee.

Preferably, said steps executed by said program further include:
(a) Maintaining a web site accessible over the Internet,
(b) accepting registrations with said Central Control Facility by Importers and Exporters accessing said web site,
(c) registering with said Central Control Facility a said Hybrid Bank Guarantee issued by a said Bank for use in at least one transaction between a registered said Importer and at least one registered said Exporter,
(d) registration of invoices for said at least one transaction; said registration valid for a nominated period,
   wherein said Hybrid Bank Guarantee guarantees payment to a said Exporter if an invoice of said Exporter registered against said Hybrid Bank Guarantee is not paid by said Importer within said nominated period.
   Preferably, a said Importer registers a Hybrid Bank Guarantee with said Central Control Facility.

Preferably, said Central Control Facility notifies a said Exporter and said Exporter's bank of a said Hybrid Bank Guarantee established on behalf of said Importer for said at least one transaction.

Preferably, said Hybrid Bank Guarantee is irrevocable unless in a first instance said Importer is not in receipt of goods or in a second instance if proof of payment has been presented by said Importer.

Preferably, if said goods are not received by a said Importer within an agreed period said Central Control Facility follows steps in accordance with processing of a letter of credit; said steps including requiring presentation by said Exporter of shipping orders, a bill of lading and shipping insurance as appropriate.

Preferably, said Exporter registers a pro form a invoice for a said transaction with said Central Control Facility; said registration of said pro form a invoice effected through said website maintained by said Central Control Facility; said registration valid for a specified period.

In another broad form of the invention, there is provided a method of facilitating import and export transactions by means of a third party Central Control Facility over a distributed communication network; said method including the steps of:
(a) said Central Control Facility maintaining a computer program on servers and data storage media,
(b) said computer program generating a website accessible to Importers and Exporters over said communication network,
(c) said program accepting data input to said website by said Importers and Exporters,
(d) said program providing for registration of a Hybrid Bank Guarantee for use in multiple said import and export transactions,
   wherein an Exporter may claim against said Hybrid Bank Guarantee for payment of an invoice registered against said Hybrid Bank Guarantee if payment by an Importer is not made within a period of registration of said invoice.

Preferably, said Importers and Exporters apply of registration with said Central Control Facility through said website generated by said program; said registration renewable annually on payment of a registration fee to said Central Control Facility.

Preferably, said Hybrid Bank Guarantee is based on a bank guarantee provided to a said Importer by said Importer's bank.

Preferably, said Hybrid Bank Guarantee is based on a bank guarantee provided to a said Importer by a bank associated with said Central Control Facility.

Preferably, notification of establishment and registration of a said Hybrid Bank Guarantee is provided by said program to a designated Exporter and said designated Exporter's bank over said communication facility.

Preferably, said program further provides for registration of a pro form a invoice submitted to said website by a said Exporter; said registration maintained by said Central Control Facility for a specified period.

Preferably, said registration of said pro form a invoice is maintained for said specified period on payment of a fee to said Central Control Facility.

In another broad form of the invention, there is provided a computer implemented import/export transaction facility for evaluation of eligibility for registration and storage against a Hybrid Bank Guarantee, of a new submitted invoice in a database of said computer; said new submitted invoice received by said computer over the Internet; said computer adding the value of said new submitted invoice to values of any prior submitted and registered invoices, to derive a new total value of invoices; said computer rejecting for registration and storage said submitted invoice if said new total value exceeds a critical value stored in said database; said computer generating an email alert of said rejection to a receiving entity which submitted said new submitted invoice; wherein said Hybrid Bank Guarantee is a financial instrument guaranteeing payment of a said invoice registered by an Exporter against said Hybrid Bank Guarantee if payment of said invoice is not made within a period of registration of said invoice.

In another broad form of the invention, there is provided a computer implemented import/export facility wherein users of said facility are provided access to designated user areas of a website and databases maintained by a Central Control Authority; said access mediated by means of a USB device releasably connected to a said user's computer; said USB device storing data relevant to authentication of a said user's identity and registration with said Central Control Authority; said USB device communicating with computers of said Central Control Authority; said users including Banks, Importers and Exporters registered with said Central Control Authority.

### BRIEF DESCRIPTION OF DRAWINGS

Embodiments of the present invention will now be described with reference to the accompanying drawings wherein:

FIG. 1 is a schematic of the interactions between Importers and Exporters with a computer based program of a Central Control Facility over a distributed communications network,

FIG. 2 is a flow diagram illustrating some of the principle interactions between the Importers, Exporters and the Central Control Facility

FIG. 3 is a flow diagram illustrating the main steps of the computer based program in the registration and monitoring of invoices submitted by a registered Exporter.

FIG. 4 is a flow diagram of a monitoring algorithm used in the computer based program.

### DETAILED DESCRIPTION OF PREFERRED EMBODIMENTS

### First Preferred Embodiment

The present invention provides for a simplified system to establish an instrument facilitating the transaction between an Importer and an Exporter of goods. In the present invention, the instrument made available to for transactions is neither a Letter of Credit nor a Bank Guarantee but a device which includes some of the attributes and modes of operation of both these well know instruments, depending on the circumstances attending the transaction; in effect a Hybrid Bank Guarantee.

Two further features of the invention include a third party to the transaction and insurance of the transaction.

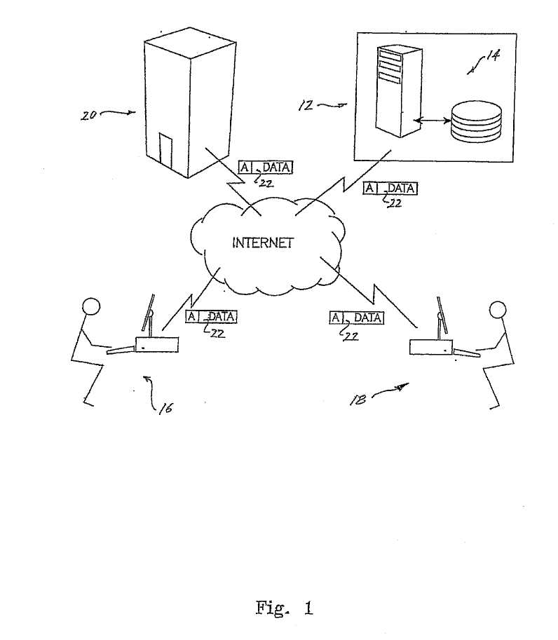

The system 10 shown in FIG. 1 provides for a third party in the form of a Central Control Facility 12 which maintains servers and databases 14, enabling the Facility 12 to communicate with Importers 16 and Exporters 18 over a distributed communication network such as the Internet 20. Data packets 22 relating to the establishment of Importer and Exporter registration, the establishment of the Hybrid Bank Guarantee and its subsequent use, are transferred between the computer systems of the Importers and Exporters and those maintained by the Central Control Facility.

A program resident on the Central Control Facility's computers executes all the critical steps in the process of establishing and executing the import/export facilitating Hybrid Bank Guarantee of the invention. The provision of the third party Central Control Facility, of which both the Importer and the Exporter become registered users, has the advantage of allowing the bona fides of both parties to be established, and over time a credit or reliability rating may be established within the Central Control Facility of all registered parties. Importers and Exporters register with the Central Control Facility by accessing a web site maintained by the Facility on the Internet and entering required data into formatted web pages provided by the program. Registration is renewable annually on payment of a fee.

The system may provide for a single instance of a transaction between a given Importer and a given Exporter, but also allows an Importer to deal with multiple Exporters and multiple transactions once a Hybrid Bank Guarantee is established with the Facility.

The Central Control Facility functions in conjunction with a financial institution such as a bank 20, and in a preferred arrangement may be a subsidiary of, or a wholly incorporated functionality within a bank.

In one preferred arrangement, an Importer who has registered with the Central Control Facility, may establish a bank guarantee with the Central Control Facility's banking arm, up to a value sufficient to cover the sort of transactions the Importer expects to enter into with one or more Exporters. These Exporters will also be registered with the Central Control Facility. Alternatively, the Importer may establish a bank guarantee with its own bank and register that guarantee with the Central Control Facility. In either arrangement, the bank guarantee is treated henceforth by the Central Control Facility as a Hybrid Bank Guarantee.

In similar manner to a normal bank guarantee, the Hybrid Bank Guarantee of the invention does not require an Importer to “lock up” any funds for the duration of a transaction, although the Importer's bank (or the Facility's bank) may require a lien over an account held with the Importer's bank or over some asset. Unlike a normal bank guarantee, the Hybrid Bank Guarantee may be used cyclically for repeated uses.

Again, unlike a normal bank guarantee, which an Importer provides to an Exporter for a single transaction, the Hybrid Bank Guarantee is retained by the Central Control Facility. The Exporter's bank and the Exporter are advised via the Central Control Facility website or by email, of its availability and its provisions.

Once the Hybrid Bank Guarantee is established, the Exporter is required to register a pro form a raised for the transaction. Registration of the pro form a invoice is also effected over the Internet through the website maintained by the Central Control Facility. This registration includes data identifying the invoice, the amount invoiced, details of the goods to be supplied, the parties to the transaction, invoice date and a period for payment. This registration is effectively an insurance covering the period specified and may be renewed by the Exporter if required. Registration attracts a fee payable to the Central Control Facility.

Similar to either a normal Letter of Credit or normal Bank Guarantee, the Hybrid Bank Guarantee is irrevocable but unlike these known instruments, it is not unconditionally irrevocable. There are two conditions or situations under which the Hybrid Bank Guarantee of the invention may be revoked. Firstly, if the goods are not received by the Importer, the Central Control Facility deals with the Hybrid Bank Guarantee in similar manner as if it was a Letter of Credit. That is, for the Exporter to receive payment for the transaction, the Central Control Facility demands documentary evidence of consignment of the goods, such as shipping orders, bill of lading, insurance etc. If these documents are in order, the Exporter is paid against the Hybrid Bank Guarantee.

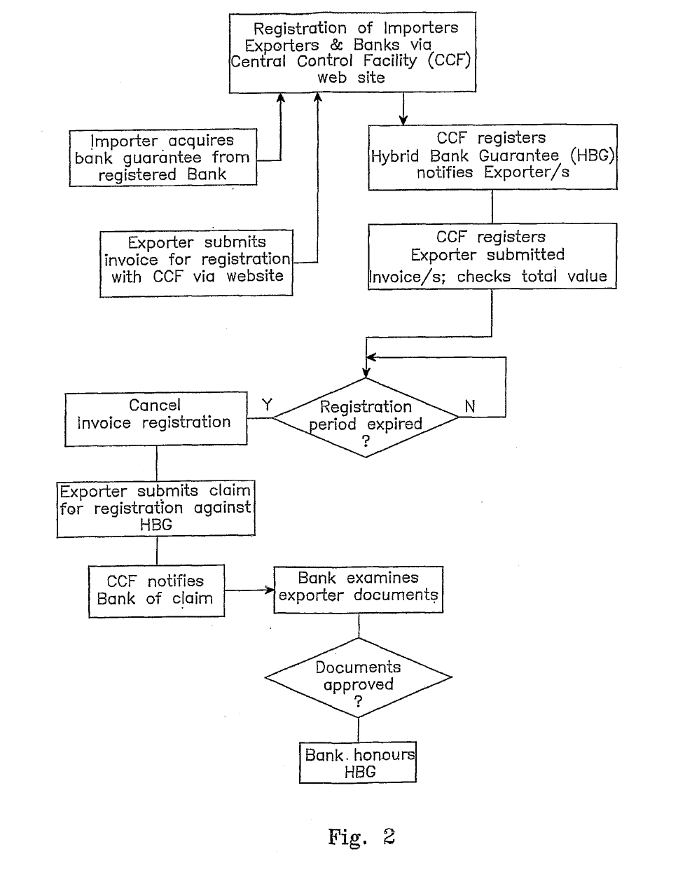

Secondly, the Hybrid Bank Guarantee is revoked (or at least its current period of validity is terminated) if proof of payment by the Importer to the Exporter on invoice, is provided by the Importer to the Central Control Facility. FIG. 2 shows a flow chart of the principle process associated with the Hybrid Bank Guarantee of the present invention.

The registration of the invoice provides insurance for the Importer for the length of the registration period. For example, an Importer and Exporter may negotiate an agreement regarding a repayment period of say three or six months. A pro form a invoice for a transaction under this agreement can be registered with the Central Control Facility for an appropriate and renewable period according to their terms of credit.

By way of example, under the agreement, an Exporter provides credit for a period of three months, but the Importer subsequently requests an extension of a further three months. If the Exporter agrees, he may register the invoice for a further three months. The Importer requests yet a further extension in which to pay, but now if the Exporter does not agree, he registers a claim against the Hybrid Bank Guarantee with the Central Control Facility before the expiry of the six months registration. The Central Control Facility now processes the documentation attaching to the transaction and, if in order, pays the Exporter.

### Second Preferred Embodiment

In a second preferred embodiment of the invention, a transaction facility, is a third party facilitating transactions between Importers and Exporters. Again with reference to FIG. 1, the third party is constituted as a Central Control Facility 12, operating a centralised computer and data storage facility 14 providing a communication and data storage hub, accessible over the Internet by parties to import/export transactions. These parties include, Importers 16, Exporters 18 and selected major banking institutions 20 operating in the countries of the Importers and Exporters using the Central Control Facility.

Participating entities, the selected Banks, Importers and Exporters, become registered entities with the Central Control Facility by means of data entry into Internet web pages generated by the Central Control Facility computer system. The details supplied are retained in the computer's data storage system.

Preferably, the databases are maintained in different sectors of the hard disc of the computer's storage media, with registered Exporters, Importers and Banks stored in a first sector, registered Hybrid Bank Guarantees and registered invoices in a second sector and registered claims in a third sector. Sectors may be further subdivided. Thus the first sector may be divided into three sections; one each for registered Exporters, registered Importers and registered Banks.

Each registered entity is enabled to access appropriate areas of the database of the Central Control Facility computer system over the Internet by means of identifying usernames and passwords.

An Exporter who is registered with the Central Control Authority may enter the appropriate area of the Authority's computer system via the Internet by providing the required security clearance. Once access has been granted, the Exporter is able to review the following data presented as web pages:
(a) all current Hybrid Bank Guarantees against which the Exporter has registered invoices and the associated expiry dates,
(b) the details of the Banks which have provided the Hybrid Bank Guarantees,
(c) details of all Importers registered with the Central Control Authority and against which invoices have been registered against Hybrid Bank Guarantees.

The open account trading system offered by the present import/export trading facility includes the following features:
(A) A third party to import/export transactions (the Central Control Facility, its Internet connected computer system, database storage facilities and staff),
(B) Generation by the Central Control Facility computer system of Hybrid Bank Guarantees (default guarantees of credit for open account trading),
(C) A hybrid insurance instrument, (Invoice Guarantee Product)
(D) An invoice monitoring algorithm implemented on the Central Control Facility computer system,
(E) Letter of Credit function of the Hybrid Bank Guarantee (in default payment of invoice situation)
(F) Bank monitoring by Internet connection to the Central Control Facility computer database of the default guarantees of credit,
(G) Importer monitoring by Internet connection to the Central Control Facility computer database of the level of default guarantee credit and the Importer's Invoice Guarantee product.
   Each of these components of the system will now be described in detail.

### A) The Central Control Facility

The third party, comprising the Central Control Facility and its Internet connected computer system and databases are central and essential to the operation of the import/export transaction system of the present invention. The computer system is programmed to fulfil the following functions:
(a) Importers in various countries who wish to avail themselves of the open account trading offered by the system, are required to register with the Central Control Facility by accessing the Central Control Facility computers and entering their relevant details into formatted web pages generated by the computer's software. Once registered, an Importer is able to access relevant sections of the computer system databases over the Internet using appropriate log-in procedures, such as by submitting valid user name and password.
(b) Similarly, Exporters in various countries who wish to use the system also must register by accessing the Central Control Facility computers and entering their relevant particulars. Again, once registered, an Exporter is able to access relevant sections of the databases over the Internet by submitting a valid log-in.
(c) At least one major Bank in each of the countries in which registered importers and exporters are located and which wish to participate in the system, are also required to register with the Central Control Facility and are thereafter enabled to access appropriate sections of the databases over the Internet, again by logging in with an appropriately secure log-in.
(d) A registered Bank may log in to a section of the Central Control Facility computer's databases allocated to that Bank for the purpose of registering on behalf of a client registered Importer, a Hybrid Bank Guarantee. All relevant details of the Guarantee are entered by the Bank into formatted web pages generated by the Central Control Facility computers. These details are then stored on the computer system's databases.
(e) Again, by accessing the Central Control Facility computer system over the Internet, a registered Bank is enabled to monitor the Hybrid Bank Guarantees (the default guaranteed credit) for each of their client registered Importers to whom a Guarantee was issued and registered by the Bank.
(f) A registered Bank can, by means of the Central Control Facility computer system, cause to be generated and transmitted over the Internet, a notification to a registered Exporter nominated by a registered Importer client of the bank, that a valid Hybrid Bank Guarantee is registered with the Central Control Facility and will be honoured by the Bank.
(g) A registered Exporter may, by accessing the Central Control Facility computer system over the Internet, register and have recorded in the computer's databases, the Exporter's invoice for a particular transaction, against a registered Importer's Hybrid Bank Guarantee.
(h) A registered Importer in turn can, by accessing the Central Control Facility computer system over the Internet, check which invoices from one or more Exporters have been registered against a Hybrid Bank Guarantee registered in the Importer's name.
(i) By the same means, the Importer can check that no invoices remain registered against his Hybrid Bank Guarantee for which payment has already been made. He is also able to check that no fraudulent invoices for goods which he has not ordered, have been so registered.
(j) The data stored in the Central Control Facility computer system databases allow an Exporter to claim against an Importer's Hybrid Bank Guarantee for a registered but unpaid invoice. Details of the claim are recorded in the database and are accessible to both the Bank, which issued the Hybrid Bank Guarantee, and the Importer.

### B) The Hybrid Bank Guarantee or “Default Guarantee Credit”

This computer generated instrument is a critical component of the open account trading system offered by the present invention. While it has similarities to both a conventional Letter of Credit and a Bank Guarantee it is a different instrument, combining some of the features of both. Its features may be summarized as follows:
(a) It is similar to a Bank Guarantee in that it guarantees payment to a registered Exporter of a registered invoice in case a registered Importer defaults on payment of the invoice,
(b) It differs from a Bank Guarantee in that
   a. it is not used as payment of “first resort” (as is the case with a Letter of Credit)
   b. it is used instead as payment of last resort, being used only in case of default of payment of a registered invoice by an Importer,
   c. unlike a Bank Guarantee it can be used again and again for multiple transactions between a registered Importer and multiple registered Exporters.
(c) The feature of multiple use is similar to that of lines of credit.
(d) It differs from lines of credit however in the following particulars,
   a. It is only used to guarantee payment by an issuing registered Bank, to an Exporter in an import/export transaction. Payment through this instrument only occurs in case of a default in payment of a registered invoice by the registered Importer of the transaction.
   b. It is restricted to use in the open account trading arrangement facilitated by the system of the present invention.
   c. Payment to a registered Exporter on a registered invoice by a registered Importer, is made by the Importer using other methods of money transfer, external and independent of the Central Control Facility; the Default Guarantee Credit is not available to the Importer as a means of payment of an invoice.

### C) Invoice Guarantee Product

This can be seen as a hybrid insurance arrangement which has some similarities to conventional insurance products available in the import and export trade.

The similarities are as follows:
(e) when in the present system of the invention a registered Exporter registers an invoice against a Hybrid Bank Guarantee issued by a registered Bank in favour of a registered Importer, the Exporter is guaranteed payment for the duration of the validity of the registration of the invoice.
(f) As in conventional insurance the Invoice Guarantee Product has a clearly defined starting date and termination date,
(g) The amount guaranteed is clearly stated,
(h) The period of validity of the Invoice Guarantee Product may be extended by renewing the registration of the invoice.

However the Invoice Guarantee Product differs from a conventional import/export insurance arrangement in significant ways as follows:
(a) unlike conventional insurance products, the Invoice Guarantee Product attracts no premiums, there being only a charge for the registration of an invoice. This constitutes a major saving over the insurance costs associated with the conducting of open account trading between geographically isolated exporters and importers,
(b) the Invoice Guarantee Product is guaranteed by the Hybrid Bank Guarantee issued by the Importer's Bank, and is in effect a by-product of the Hybrid Bank Guarantee,
(c) conventional insurance products do not provide for registration of invoices,
(d) the system of the invention does not rely on an insurance policy for claims. Claims made against a Hybrid Bank Guarantee are based on the Letter of Credit principles as provided by law,
(e) again, unlike conventional insurance, the Central Control Facility of the present system utilises the registration of invoices to track the completion of import/export transactions. Since maintaining registration of an invoice incurs a cost, the Exporter will terminate registration when payment from the importer has been received, thus confirming completion of the transaction. The withdrawal of registration may also allow further invoices to be registered against the Hybrid Bank Guarantee (as will be explained further below).

The feature of registration of invoices provides a greatly simplified method of monitoring and managing import/export transactions. It is stressed that the Invoice Guarantee Product is not an insurance product. Rather it is a novel instrument concomitant with the Hybrid Bank Guarantee, which provides for security of open account trading at low cost.

### D) Invoice Monitoring System

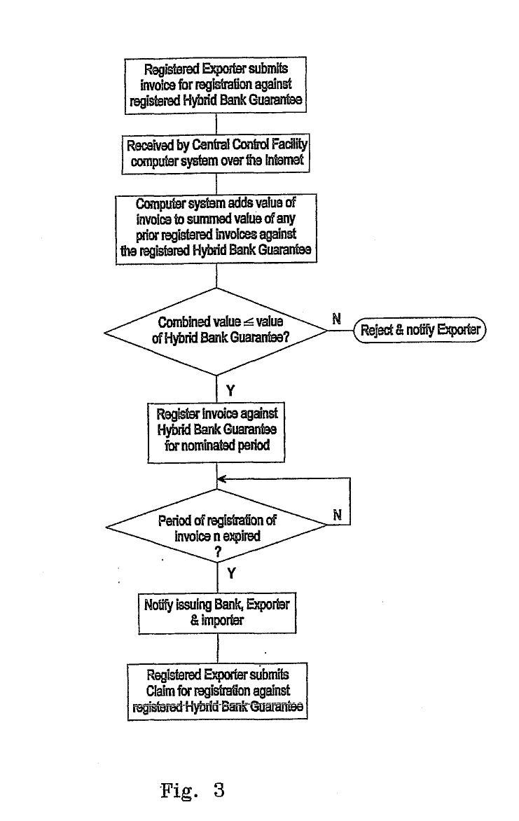

The registration, in the computer system databases of the Central Control Facility, of invoices by registered Exporters, allows both a registered Bank which issues a Hybrid Bank Guarantee and the registered Importer on whose behalf the Hybrid Bank Guarantee is registered with the Central Control Facility, to monitor which Exporters are secured against the Hybrid Bank Guarantee at any one time. The process of monitoring the registration of invoices is shown schematically in the flow diagram of FIG. 3.

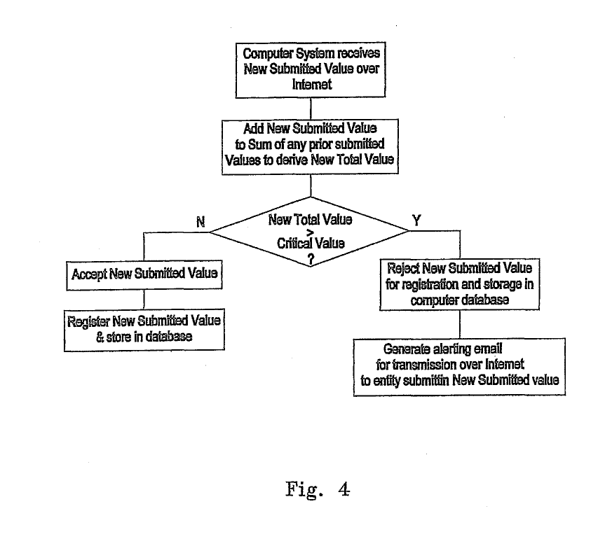

The computer system software monitors each invoice which is submitted to the system for registration and storage in the database against a registered Hybrid Bank Guarantee, adding the invoice value to the summation of values of those invoices (if any) prior registered against that Hybrid Bank Guarantee. Should the summed new total value exceed the value of the Hybrid Bank Guarantee (the critical value), the registration of the invoice is rejected and the computer generates advice (for example in the form of an email) to each party; that is the Hybrid Bank Guarantee issuing bank, the Importer and the Exporter. The algorithm employed by the computer system is shown in FIG. 4. As explained above, the issuing Bank is of course able to itself monitor the status of the Hybrid Bank Guarantee which it has registered with the Central Control Facility.

As well as monitoring that the value of registered invoices does not exceed the value of the issued Hybrid Bank Guarantee, the computer system software monitors the elapse of the registration period of registered invoices. For example, if the Exporter has agreed to a credit period of 6 months from the date of registration of the invoice, he will be required to maintain the registration for that period. Renewal of registration may be on a monthly basis or three monthly for example.

The Central Control Facility computer system may generate automatic reminders that a period of registration is close to expiry and issue notification when it has expired. (Of course, the registered Exporter is able to monitor his invoices at any time by accessing the computer system databases as explained above).

The Exporter will continue to maintain the registration of the invoice until it is paid by the Importer, after which the Exporter will no longer have any need of the Invoice Guarantee Product provided by its registration and will either access the system to cancel the registration, or not renew it through cessation of payment of fees, in effect allowing the registration to lapse.

Should the Exporter come to an agreement with an Importer to further extend the period of credit, the flexibility of the system simply allows him to renew the registration of the invoice by accessing the Central Control Facility computer system and entering the required details and payment of the additional registration fee.

Should the Exporter not have received payment of his registered invoice by the time of the expiry of the registration period, the Exporter may register a claim with the Central Control Facility computer system, which passes the relevant details to the issuing Bank as well as alerting the Importer to the submission of the claim.

Once payment against a registered invoice has been received by an Exporter, it is in the Exporter's interest to delete that registration from the Central Control Authority records. The Exporter is enabled to do this by accessing that relevant web page of the Authority's database which lists the invoice and the Hybrid Bank Guarantee against which it is registered. A clearing button is provided on the web page which, when “clicked” triggers a security process which includes the following steps:
(a) the Exporter is required to answer one or more security questions randomly selected from a number of predefined questions nominated by the Exporter at the time of registering with the Authority,
(b) if the questions are answered correctly, an email is forwarded by the Authority to the Bank issuing the Hybrid Bank Guarantee advising the Bank that the invoice registration will be deleted,
(c) a delay, preferably of two days, is allowed to elapse before the Authority deletes the invoice from the system.

In the case of the Importer, the Central Control Authority provides for the Importer to request that a Hybrid Bank Guarantee be deleted from the Authority's database in similar manner to the process described for the Exporter above. In this case, the Authority
(a) checks that no invoices remain registered against the Hybrid Bank Guarantee,
(b) transmits an email advising the issuing Bank that the Hybrid Bank Guarantee is to be deleted within a given period, for example in a week's time,
(c) one or two days before the elapse of that week, the Authority may transmit a reminder to both the Bank and the Importer that deletion will occur.

### E) The Letter of Credit Function of the Hybrid Bank Guarantee: Claims Against

If a default in payment occurs, that is, the period of registration of an invoice expires without the Exporter having received payment from the Importer, the Exporter may register a claim with the Central Control Facility against the registered Hybrid Bank Guarantee issued by the registered Bank in favour of the Importer.

The software of the facility will check that the claim can be registered by confirming that the registration period for the invoice has expired and notify the Bank accordingly. Alternatively, the Bank can make this check by accessing the Facility's database. The software will also notify the Importer that a claim has been registered.

In the situation of payment default, the Hybrid Bank Guarantee is treated by the issuing registered Bank as a Letter of Credit in the same way, and subject to the same legal requirements, as a conventional letter of credit. To substantiate the claim the Bank will require of the Exporter the shipping order, bill of lading, copy of the pro-form a invoice (the registered invoice). The Bank will check by accessing the Central Control Facility's databases that the invoice presented for claim is the same and for the same value as the registered invoice recorded in the database against the Hybrid Bank Guarantee.

Assuming the veracity of the Exporter's documentary evidence of supply of goods and a lack on the Importer's part of proof of payment of the registered invoice, the registered Bank will make a default payment to the Exporter.

In the letter of credit according to the invention (advanced form) four variables are standardized, namely:
a) 90 days credit
b) the exporters to pay cost of shipping. (freight cost)
c) the exporter to pay for shipping insurance (freight insurance).
d) expiry date of the letter of credit (advanced form) is 1 year from date of issue.

In the letter of credit according to the invention, (advanced form) three unique features are provided, namely:
a) a valid invoice registration
b) a valid claim form
c) claim is not valid if there is evidence of payment.
d) Option for exporter to pay bank charges for this letter of credit (advanced form) and the charges to be deducted from this letter of credit (advanced form) for this transaction.

### Advantages:

a) fixed variable leads to decreased risks of fraud, decreased risks of dispute on non-delivery of exports and decreased risks of dispute on delivery of damaged exports.
b) new features:
allows the checking of a valid hybrid line of credit over the internet.
allows monitoring of the status of invoice payment over the internet.
allows extension of credit by exporter by renewing the invoice registration.
allows flexibility of payment by importer by telegraphic transfer.
allows exporter to deregister the invoice registration after TT payment
allows exporter to claim via Letter of Credit if there is default or dispute.
   c) general benefits:
this letter of credit (advanced form) is simple and easier to issue. This means less cost.
allows flexibility of payment. Majority of import/export trade is paid either by TT or in default by direct payment by banks (like credit card) payment.
allows dispute resolution via the laws of letter of credit in a small number of cases.
in majority of import/export transaction under this patent, inspection of export documents is not longer required. Only in a small percentage of cases of disputes is inspection and checking of export documents required.

### F) Bank Monitoring of Bank-Issued Hybrid Bank Guarantees

As noted above, the computer system maintained by the Central Control Facility provides access to a Bank registered with the facility, to that section (the Bank's Account) of the computer system's databases dealing with the registration of invoices against any Hybrid Bank Guarantee the Bank has registered with the Facility. Access is by an authorized officer of the Bank to log into the Facilities computers.

Thus the Bank is enabled to monitor the status of an Hybrid Bank Guarantee issued to a registered Importer and the invoices for transactions the Importer has entered into which are registered against it.

G) Importer monitoring of the Hybrid Bank Guarantee and the Invoice Guarantee Product

Each registered Importer may, by logging into the Central Control Facility's computer system over the Internet, view the invoices currently registered by Exporters against a Hybrid Bank Guarantee issued by his registered Bank.

The import/export facility of the present invention thus provides Default Guarantee Credit to Exporters registered with the Central Control Facility, allowing open account trading between the Exporter and the Importer. A particular distinction between the Hybrid Bank Guarantee, which provides this credit guarantee, and a conventional letter of credit is that Hybrid Bank Guarantee is only used to pay an invoice in case the Importer fails to do so within a time frame attached to the registration of the invoice. Normally, payment of the invoice is made by the Importer without reference to the Central Control Facility, using any conventional means of payment, such as electronic transfer between accounts for example.

The facility offers in effect an insurance (referred to above as the Invoice Guarantee Product), which extends automatically from the operation of the Hybrid Bank Guarantee. Thus an Exporter can avoid the high cost of insuring his transactions, instead paying a modest fee to the Central Control Facility for the duration of registration of his invoices.

In a default situation in which payment to the Exporter by the Importer has not been made within the time period of registration of the invoice, a claim made against the registered Hybrid Bank Guarantee retains the advantages at law of a conventional Letter of Credit and is processed by the registered Bank in accordance with standard Letter of Credit procedures.

Central to the operation of the present invention is the Central Control Facility computer system. It is by means of Exporters, Importers and Banks accessing this computer system over the Internet, that the various functions of the import/export facility are realized. Registrations of the parties to import/export transactions, registrations and monitoring of invoices, registrations of the Hybrid Bank Guarantees and of claims, are all mediated by the computer system maintained by the Central Control Facility. It is the computer system also which allows the participating parties to access data stored on the computer system databases and monitor the status of the registered instruments; the Hybrid Bank Guarantees and the invoices registered against them. Again it is the computer system which enables an Exporter to register a claim against a registered Hybrid Bank Guarantee should a default in payment on the part of an Importer occur.

It will be understood that security of access by the parties to the Central Control Authority web site and sections of its databases is essential for the parties to have confidence in the facility. To this end the facility of the present invention provides for a User Identification Device for use by the parties when accessing the facility.

The facility may provide for 2 levels of identification. Level 1 is for lower level of security. Level 2 is for higher level of security.

Level 1 comprises a device encrypted with the user's identification data. It is attached to the USB port of the user's computer. The Central Control Authority website has to verify the data on the USB device after the user has entered his or her username and password and before access to the Authority' website is granted.

Level 2 is similar to level 1 except it has other security questions. The user puts in the questions and answers at the time of registering with the Central Control Authority as a Bank, an Importer or an Exporter. The answers are recorded on the USB device. Every time the user wants access to the Authority's website, those security questions will be asked. The website checks the answers before allowing the user to access the appropriate area/s of the Authority's databases.

Level 2 user personal identification device has the following features:
a) it contains identification data linking the device to user-accessible area of the Authority's website.
b) The identification data is changed every time the device is lost or security is breached.
c) There are security questions. The user nominates the security questions and answers. The answers are recorded and saved on a special designated space in the device. The user has to answer the questions twice to ensure the correct answers are put in the area (like entry of pin number).
d) The user can edit the questions and answers. He can use an edit button only after he has answered the security questions correctly. After using the edit button, he puts in new questions and answers. He has to put in the answers twice before the questions and answers are saved.
e) Every time a user wishes to enter the Authority's website, the username and password must be entered for access to the users area of the website. Before he is allowed into his user area, the website will ask him the security questions of the personal identification device. The answers are temporarily saved in similar designated area in the identification device.
f) The website will check for the correct identification data in the personal identification device. Then it will check the stored answers area of the personal identification device and the temporarily answers area. If the two areas are identical, the website will allow entry to the user website.
g) This personal identification device is quite fool-proof against hacking. The security of the website can be breached by hacking. The reason is that the security questions data of the identification device is not stored in the website. The hackers may get into the website, they may get the username, password or even identification data of the level 1 of the personal identification device. But they cannot get the security questions data of the personal identification device as the device is with the user and not in the website.
h) When the personal identification device is lost, the personal identification device will be replaced and the identification data changed on replacement.

### In Use

An advantage of the present system resides in the processing by the program maintained on the Central Control Facility of the registration of all parties to an import/export transaction via the communication network of the Internet, and the Facility's monitoring of the Hybrid Bank Guarantee, and the invoices registered against it. The system allows Exporters to extend credit at minimum risk; effectively the same risk as associated with a Letter of Credit, allowing them to operate on an open account payment basis.

Further advantages include that an Exporter can extend credit to Importers at minimum risk; in effect at similar risk to that of a normal Letter of Credit. This extension of credit at minimum risk allows an Exporter to promote its trade, facilitating the smooth flow of international trade.

An advantage of the computer generated Hybrid Bank Guarantee for Importers is that it can be used many times by an Importer dealing with multiple Exporters registered with the Central Control Facility. A further advantage is that, being a computer based system with interactions enabled over the Internet, large numbers of transactions can be processed and monitored by the Central Control Facility over the extended time periods involved in international trade.

The above describes only some embodiments of the present invention and modifications, obvious to those skilled in the art, can be made thereto without departing from the scope of the present invention.

What is claimed is:

1. An import/export facility; said facility including computer implemented software resident on servers and databases maintained by a Central Control Facility; said software providing for registration of Importers and Exporters and at least one Bank in each country of operation of registered said Importers and Exporters; said registration effected by accessing Internet web pages generated and transmitted by said software; said at least one Bank registering on behalf of a said registered Importer, a Hybrid Bank Guarantee with said Central Control Facility; a registered Exporter registering with said Central Control Facility an invoice against said Hybrid Bank Guarantee for a transaction with a said registered Importer, and wherein said software executes steps to monitor registered invoices against said Hybrid Bank Guarantee; said steps including:
(a) adding the value of an invoice submitted for registration to a sum of values of invoices (if any) prior registered against said Hybrid Bank Guarantee to derive a total value,
(b) comparing said derived total value to the value of said registered Hybrid Bank Guarantee against which said invoice was submitted for registration,
(c) registering said invoice against said registered Hybrid Bank Guarantee of the registered Importer to whom said invoice is directed if said total value does not exceed the value of said Hybrid Bank Guarantee,
(d) maintaining registration of a said invoice for a period nominated by a said registered Exporter on payment of a registration fee,
and wherein said computer system rejects for registration any invoice submitted for registration by a said Exporter against a said Hybrid Bank Guarantee if said derived total value is greater than the value of said Hybrid Bank Guarantee; said computer system generating, and causing to be transmitted, email advice of rejection to said Exporter and to said Importer; and wherein said Exporter may claim against said Hybrid Bank Guarantee if payment of a registered invoice is not made by said Importer within a nominated registration period of said invoice.

2. The facility of claim 1, wherein each of a said registered Importer, a said registered Exporter and a said registered Bank, being parties to an import/export transaction, is afforded access to appropriate sections of said databases over the Internet; said access enabled on provision of authentication of identity.

3. The facility of claim 1, wherein registration of an invoice by a said Exporter with said Central Control Facility is for a nominated registration period agreed between a said registered Exporter and a said registered Importer.

4. The facility of claim 1, wherein registration of a said invoice is maintained in said databases by said Central Control Facility on payment of a fee.

5. The facility of claim 1, wherein a said registered Importer makes payment against an invoice registered with said Central Control Facility by any payment means without reference to said Central Control Facility.

6. The facility of claim 3, wherein said computer system of said Central Control Facility alerts each of said registered Exporter, said registered Bank and said registered Importer being parties to an import/export transaction, to the expiry of a said nominated registration period of a said invoice registered against said Hybrid Bank Guarantee.

7. The facility of claim 3, wherein a said registered Exporter is guaranteed payment of a said invoice registered against a said Hybrid Bank Guarantee by said registered Bank which issued said Hybrid Bank Guarantee, if said registration period for said invoice expires without payment of said invoice being received by said Exporter from said Importer.

8. The facility of claim 3, wherein a said registered Exporter who has not received payment from a said registered Importer of a registered invoice at expiry of a said registration period of said invoice, is enabled to register a claim against a said Hybrid Bank Guarantee against which said invoice was registered.

9. The facility of claim 1, wherein said computer implemented software alerts a said registered Bank and a said registered Importer of a claim against a Hybrid Bank Guarantee issued by said Bank in favour of said Importer.

10. A method of securing default payment of an invoice for an import/export transaction between an Exporter and an Importer registered with a Central Control Facility; said method including the steps of:
(a) said Exporter submitting said invoice for registration for a nominated period with said Central Control Facility; said invoice registered against a Hybrid Bank Guarantee issued by a registered Bank and registered with said Central Control Facility in favour of said Importer,
(b) a computer system of said Central Control Facility adding the value of said submitted invoice to a total value of invoices (if any) prior registered against said Hybrid Bank Guarantee to derive a new total value,
(c) said computer system comparing said new total value to the value of said Hybrid Bank Guarantee,
(d) said computer system registering said invoice with said Central Control Facility if said new total value is not greater than said value of said Hybrid Bank Guarantee,
(e) said Exporter registering a claim against said registered Hybrid Bank Guarantee only if said Importer has not paid said registered invoice within said nominated period of registration of said invoice,
(f) said registered Bank making payment of said registered invoice to said Importer and wherein said computer executes steps, firstly rejecting registration of said invoice, and secondly generating alerting emails to said Exporter and to said Importer, if said new total value is greater than said value of said Hybrid Bank Guarantee.

11. The method of claim 10, wherein said registered Bank makes payment of said registered invoice only in a default situation; said default situation occurring if:
(a) a said nominated registration period of said registered invoice has expired,
(b) said registered Exporter has registered a claim with said Central Control Facility,
(c) documentary evidence of supply of goods is verified by said registered Bank,
(d) said registered Importer cannot provide proof of payment of said registered invoice.

12. An import/export facilitating computer system providing a communication and data storage hub; said system maintained by a Central Control Facility said computer including servers and databases accessible over the Internet by registered parties to import/export transactions; said computer system having the following functions:
(a) generating and transmitting formatted web pages displayable over said Internet for submission by said parties of data for registration of said parties with said Central Control Facility; said parties comprising Exporters, Importers and at least one Bank in each country in which said Exporters and Importers are located,
(b) storage of said data in said databases,
(c) providing formatted web pages for storage of details provided by a registered said Bank of a Hybrid Bank Guarantee issued by said Bank in favour of a registered said Importer,
(d) providing details over the Internet of a registered said Hybrid Bank Guarantee to one or more registered Exporters nominated by said Importer for whom said Hybrid Bank Guarantee was issued,
(e) providing formatted web pages for submitting for registration by a said nominated Exporter one or more invoices against said Hybrid Bank Guarantee,
(f) summing the values of any prior registered invoices against a said Hybrid Bank Guarantee and adding the value of a newly submitted invoice by said nominated Exporter to derive a new total value,
(g) registering said newly submitted invoice against said Hybrid Bank Guarantee if said new total value does not exceed the value of said Hybrid Bank Guarantee, and wherein said computer system rejects for registration any invoice submitted for registration by a said nominated Exporter against a said Hybrid Bank Guarantee if said new total value is greater than the value of said Hybrid Bank Guarantee; said computer system generating, and causing to be transmitted, email advice of rejection to said nominated Exporter and to said Importer; and wherein said nominated Exporter may claim against said Hybrid Bank Guarantee if payment of a registered invoice is not received within a nominated period of registration of said invoice.

13. The computer system of claim 12, wherein each invoice registered against a said Hybrid Bank Guarantee is registered for a period of registration on payment of a registration fee; said period of registration agreed between a said Exporter and a said Importer for an import/export transaction.

14. The computer system of claim 12, wherein said Hybrid Bank Guarantee provides guarantee of payment of an invoice registered with said Central Control Facility against said Hybrid Bank Guarantee if said Importer, in favour of whom said Hybrid Bank Guarantee was issued, has not paid said invoice within a period of registration of said invoice.

15. An import/export transaction facility; said facility including a computer implemented program; said program resident on servers maintained by a Central Control Facility; said program executing steps including:
(a) registering Importers and Exporters with said Central Control Facility,
(b) registering and managing a financial instrument issued in favour of a said registered Importer,
(c) monitoring values of invoices submitted for registration against said financial instrument, wherein said Central Control Facility acts as a third party monitor in the execution of said financial instrument; said financial instrument comprising a Hybrid Bank Guarantee whereby said Hybrid Bank Guarantee guarantees payment of an invoice registered by said Central Control Facility against said Hybrid Bank Guarantee if said invoice is not paid by said registered Importer within a period of registration of said invoice.

16. The facility of claim 15, wherein said financial instrument combines principles of both a letter of credit and a bank guarantee; said financial instrument forming a Hybrid Bank Guarantee.

17. The facility of claim 15, wherein said steps executed by said program further include:
(a) maintaining a web site accessible over the Internet,
(b) accepting registrations with said Central Control Facility by Importers and Exporters accessing said web site,
(c) registering with said Central Control Facility a said Hybrid Bank Guarantee issued by a said Bank for use in at least one transaction between a registered said Importer and at least one registered said Exporter,
(d) registration of invoices for said at least one transaction; said registration valid for a nominated period, wherein said Hybrid Bank Guarantee guarantees payment to a said Exporter if an invoice of said Exporter registered against said Hybrid Bank Guarantee is not paid by said Importer within said nominated period.

18. The facility of claim 15, wherein a said Importer registers a Hybrid. Bank Guarantee with said Central Control Facility.

19. The facility of claim 18, wherein said Central Control Facility notifies a said Exporter and said Exporter's bank of a said Hybrid Bank Guarantee established on behalf of said Importer for said at least one transaction.

20. The facility of claim 16, wherein said Hybrid Bank Guarantee is irrevocable unless in a first instance said Importer is not in receipt of goods or in a second instance if proof of payment has been presented by said Importer.

21. The facility of claim 20, wherein if said goods are not received by a said Importer within an agreed period said Central Control Facility follows steps in accordance with processing of a letter of credit; said steps including requiring presentation by said Exporter of shipping orders, a bill of lading and shipping insurance as appropriate.

22. The facility of claim 15, wherein said Exporter registers a pro form a invoice for a said transaction with said Central Control Facility; said registration of said pro form a invoice effected through said website maintained by said Central Control Facility; said registration valid for a specified period.

23. A method of facilitating import and export transactions by means of a third party Central Control Facility over a distributed communication network; said method including the steps of:
(a) said Central Control Facility maintaining a computer program on servers and data storage media,
(b) said computer program generating a website accessible to Importers and Exporters over said communication network,
(c) said program accepting data input to said website by said Importers and Exporters,
(d) said program providing for registration of a Hybrid Bank Guarantee for use in multiple said import and export transactions, wherein an Exporter may claim against said Hybrid Bank Guarantee for payment of an invoice registered against said Hybrid Bank Guarantee if payment by an Importer is not made within a period of registration of said invoice.

24. The facility of claim 23, wherein said Importers and Exporters apply of registration with said Central Control Facility through said website generated by said program; said registration renewable annually on payment of a registration fee to said Central Control Facility.

25. The facility of claim 23, wherein said Hybrid Bank Guarantee is based on a bank guarantee provided to a said Importer by said Importer's bank.

26. The facility of claim 23, wherein said Hybrid Bank Guarantee is based on a bank guarantee provided to a said Importer by a bank associated with said Central Control Facility.

27. The facility of claim 23, wherein notification of establishment and registration of a said Hybrid Bank Guarantee is provided by said program to a designated Exporter and said designated Exporter's bank over said communication facility.

28. The facility of claim 23, wherein said program further provides for registration of a pro form a invoice submitted to said website by a said Exporter; said registration maintained by said Central Control Facility for a specified period.

29. The facility of claim 28, wherein said registration of said pro form a invoice is maintained for said specified period on payment of a fee to said Central Control Facility.

30. A computer implemented import/export transaction facility for evaluation of eligibility for registration and storage against a Hybrid Bank Guarantee, of a new submitted invoice in a database of said computer; said new submitted invoice received by said computer over the Internet; said computer adding the value of said new submitted invoice to values of any prior submitted and registered invoices, to derive a new total value of invoices; said computer rejecting for registration and storage said submitted invoice if said new total value exceeds a critical value stored in said database; said computer generating an email alert of said rejection to a receiving entity which submitted said new submitted invoice; wherein said Hybrid Bank Guarantee is a financial instrument guaranteeing payment of a said invoice registered by an Exporter against said Hybrid Bank Guarantee if payment of said invoice is not made within a period of registration of said invoice.
